(19) United States
(12) Patent Application Publication
(10) Pub. No.: US 2014/0085208 A1
(43) Pub. Date: Mar. 27, 2014

(54) TOUCHSCREEN DEVICE AND ELECTRONIC DEVICE USING THE SAME

(71) Applicant: Samsung Electro-Mechanics Co., Ltd., Suwon (KR)

(72) Inventors: Sang Hyun Sim, Suwon (KR); Yoon Seok Oh, Suwon (KR); Ji Hoon Kim, Suwon (KR)

(73) Assignee: Samsung Electro-Mechanics Co., Ltd., Suwon (KR)

(21) Appl. No.: 13/965,659

(22) Filed: Aug. 13, 2013

(30) Foreign Application Priority Data
Sep. 25, 2012 (KR) 10-2012-0106661

(51) Int. Cl. G06F 3/041; G06F 3/02

(52) U.S. Cl. CPC G06F 3/0412; G06F 3/0227
USPC 345/169

(57) ABSTRACT

There are provided a touchscreen device capable of preventing a typing error of a touch keyboard, and an electronic device using the same. The touchscreen device includes a display unit outputting a keyboard touch region including a touch keyboard, a touchscreen to which a touch is made, and a control unit controlling the display unit to output an expanded keyboard having a preset shape by expanding a touch region of a first touch when the first touch is sensed in the keyboard touch region, wherein the first touch is a floating or hovering touch.

### CROSS-REFERENCE TO RELATED APPLICATIONS

This application claims the priority of Korean Patent Application No. 10-2012-0106661 filed on Sep. 25, 2012, in the Korean Intellectual Property Office, the disclosure of which is incorporated herein by reference.

### BACKGROUND OF THE INVENTION

1. Field of the Invention

The present invention relates to a touchscreen device capable of preventing a typing error in a touch keyboard, and an electronic device using the same.

2. Description of the Related Art

A touch sensing apparatus such as a touchscreen, a touch pad, or the like, an input apparatus attached to a display apparatus to provide an intuitive data input method to a user, has recently been widely used in various electronic devices such as cellular phones, personal digital assistants (PDAs), navigation devices, and the like. Particularly, as demand for smartphones has recently increased, the use of touchscreens as a touch sensing apparatuses capable of providing various input methods in a limited form factor has correspondingly increased.

Touchscreens used in a portable device may be mainly divided into a resistive type touchscreen and a capacitive type touchscreen according to a method of sensing a touch input utilized thereby. Here, the capacitive type touchscreen has advantages in that it has a relatively long lifespan and may easily implement various input methods and gestures, such that the use thereof has correspondingly increased. Particularly, capacitive type touchscreens may more easily allow for a multi-touch interface as compared with resistive type touchscreens, such that they are widely used in devices such as smartphones, and the like.

As a method for inputting letters, numbers, symbols, and the like using the touchscreen, a touch keyboard has been used. However, unlike a physical keyboard, since the touch keyboard may not provide a physical flexure felt by a finger, a typing error may occur relatively easily.

The following related art document relates to a multi-event input system and discloses a technology expanding a touched keyboard key to judge the touched keyboard key when a touch is made to a touch keyboard in order to improve an input typing error of the touchscreen.

However, since the following related art may confirm the touched keyboard key after the touch is made, but may not confirm the keyboard key to be touched before the touch is made, the typing error may not be efficiently prevented.

### RELATED ART DOCUMENT

United State Patent Application Publication No. 2012/0011462

### SUMMARY OF THE INVENTION

An aspect of the present invention provides a touchscreen device capable of confirming a position of a finger before a touch is made to a touch keyboard, and an electronic device using the same.

According to an aspect of the present invention, there is provided a touchscreen device, including: a display unit outputting a keyboard touch region including a touch keyboard; a touchscreen to which a touch is made; and a control unit controlling the display unit to output an expanded keyboard having a preset shape by expanding a touch region of a first touch when the first touch is sensed in the keyboard touch region, wherein the first touch is a floating or hovering touch.

The touch keyboard may include a plurality of keyboard keys, and the control unit may control the display unit to display the keyboard key having the highest change in capacitance caused by the first touch among the keyboard keys included in the touch region of the first touch in the expanded keyboard, with a preset emphasis color, when the first touch is sensed in the keyboard touch region.

The control unit may control the display unit to output a plurality of the expanded keyboards corresponding to a plurality of first touches, respectively, when the plurality of first touches are sensed in the keyboard touch region.

The preset shape may be one of a circular shape, a quadrangular shape, and a triangular shape.

The control unit may control the display unit to output the expanded keyboard in a region of a screen other than the keyboard touch region.

The display unit may include a display region for displaying a preset letter corresponding to a keyboard key of the touch keyboard, and the control unit may control the display unit to output the expanded keyboard in a state in which the expanded keyboard is spaced apart from a cursor included in the display region by a predetermined distance.

According to an aspect of the present invention, there is provided a touchscreen device, including: a display unit outputting a keyboard touch region including a touch keyboard; a touchscreen to which a touch is made; and a control unit controlling the display unit to output an expanded keyboard having a preset shape by expanding a touch region of a sensed touch when one of a first touch, a second touch, and a third touch is sensed in the keyboard touch region, wherein the first touch has a change in capacitance from a preset first reference value or above to below a preset second reference value, the second touch has a change in capacitance from the second reference value or above to below a preset third reference value, and the third touch has a change in capacitance of the third reference value or above.

The touch keyboard may include a plurality of keyboard keys, and the control unit may control the display unit to display the keyboard key having the highest change in capacitance caused by a sensed touch among the keyboard keys included in the touch region of the sensed touch in the expanded keyboard with a preset emphasis color when one of the first touch, the second touch, and the third touch is sensed in the keyboard touch region.

The preset emphasis colors may be different from each other to correspond to the first touch, the second touch, and the third touch, respectively.

The control unit may control the display unit to output a plurality of the expanded keyboards corresponding to a plurality of sensed touches, respectively, when one of the first touch, the second touch, and the third touch is sensed in the keyboard touch region in plural.

The control unit may control the display unit to output a plurality of the expanded keyboard corresponding to a plurality of sensed touches, when a plurality of touches corresponding to the first touch, the second touch, and the third touch, are respectively sensed in the keyboard touch region.

The display unit may include a display region for displaying a preset letter corresponding to a keyboard key of the touch keyboard, and the control unit may control the display unit to output the letter of the keyboard key corresponding to a touch having the second reference value or above in the display region, when the touch having the second reference value or above is sensed in the keyboard touch region.

The display unit may include a display region for displaying a preset letter corresponding to a keyboard key of the touch keyboard, and the control unit may control the display unit to output the letter of the keyboard key corresponding to a touch having the third reference value or above in the display region, when the touch having the third reference value or above is sensed in the keyboard touch region.

The control unit may control the display unit to output the expanded keyboard in a region of a screen other than the keyboard touch region.

The display unit may include a display region for displaying a preset letter corresponding to a keyboard key of the touch keyboard, and the control unit may control the display unit to output the expanded keyboard in a state in which the expanded keyboard is spaced apart from a cursor included in the display region by a predetermined distance.

The preset shape may be one of a circular shape, a quadrangular shape, and a triangular shape.

According to an aspect of the present invention, there is provided an electronic device including the touchscreen device as described above.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a front view of an electronic device including a touchscreen device according to an embodiment of the present invention;

FIGS. 2, 3A, 3B and 3C are views provided to describe classification of a touch according to an embodiment of the present invention; and

FIGS. 4 through 6 are views illustrating an expanded keyboard according to an embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

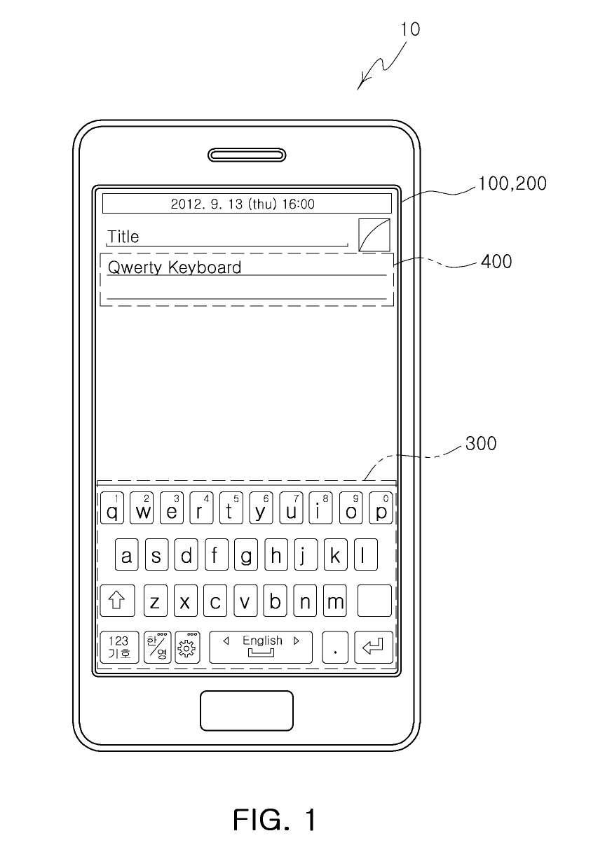

FIG. 1 is a front view of an electronic device 10 including a touchscreen device according to an embodiment of the present invention. The electronic device 10 of FIG. 1 refers to a wide variety of electronic devices 10 including a touchscreen 200, such as a portable communications terminal.

Referring to FIG. 1, the electronic device 10 according to the embodiment of the present invention may include a display unit 100 to allow a screen to be displayed therethrough, a touchscreen 200 receiving a touch, and a control unit (not shown). In addition, the electronic device 10 may include an audio unit for outputting audio in addition to the above-mentioned components, and the like.

The display unit 100 may output a keyboard touch region 300 including a touch keyboard. The touch keyboard refers to a touch keyboard for inputting letters, numbers, symbols, and the like using the touch by a touch input apparatus, and the touch keyboard may include a plurality of keyboard keys.

In addition, the display unit 100 may include a display region 400 for displaying the keyboard key of the touch keyboard. Specifically, the display region 400 refers to a portion to which a preset letter corresponding to the keyboard key may be output when the keyboard key is touched.

As shown in FIG. 1, in the case of the portable terminal, the touchscreen 200 may be generally provided in a state in which it is integrated with the display unit 100 and needs to have a degree of light transmissivity high enough to penetrate a screen displayed by the display unit 100. Therefore, the touchscreen 200 may be implemented by forming a sensing electrode on a base substrate formed of a transparent film material such as polyethylene terephtalate (PET), polycarbonate (PC), polyethersulfone (PES), polyimide (PI), or the like, using a transparent and electrically conductive material such as indium tin oxide (ITO), indium zinc oxide (IZO), zinc oxide (ZnO), carbon nanotubes (CNT), or graphene. The display may include a wiring pattern disposed in a bezel region thereof, wherein the wiring pattern is connected to the sensing electrode formed of the transparent and conductive material. Since the wiring pattern is visually shielded by the bezel region, it may also be formed of a metal such as silver (Ag), copper (Cu), or the like.

Since it is assumed that the touchscreen device according to the embodiment of the present invention is operated in a capacitive manner, the touchscreen device may include a plurality of electrodes having a predetermined pattern. In addition, the touchscreen device according to the embodiment of the present invention may include a capacitance sensing device for detecting a change in capacitance generated in the plurality of electrodes.

The control unit may sense the change in capacitance generated by the touch and a position of the change in capacitance when the touch is made to the touchscreen 200. The control unit may compare the change in capacitance with a first reference value, a second reference value, and a third reference value, all of which are preset, and may classify the touch into a first touch, a second touch, and a third touch.

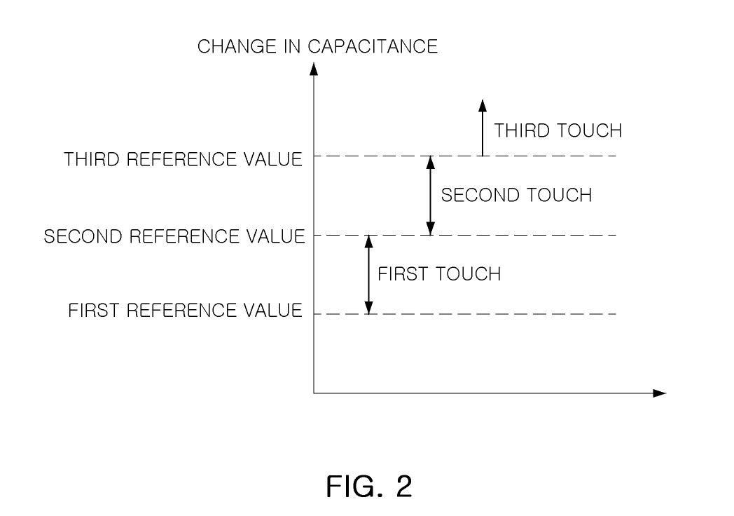

FIG. 2 is a view provided to describe classification of a touch according to an embodiment of the present invention.

As shown in FIG. 2, it may be appreciated that the change in capacitance is increased in order of the first reference value, the second reference value, and the third reference value. The control unit may judge a case in which the change in capacitance is the first reference value or above to a value below the second reference value, as a first touch, may judge a case in which the change in capacitance is the second reference value or above to a value below the third reference value, as a second touch, and may judge a case in which the change in capacitance is the third reference value or above, as a third touch.

The first touch refers to a touch in a state in which the touch input apparatus does not contact the touchscreen 200 and is spaced apart from the touchscreen 200 by a predetermined distance or further. The touchscreen device by the capacitive type may sense the change in capacitance even in the case in which the touch input apparatus floats above the touchscreen 200 by a few millimeters (mm), where this touch may be referred to as a floating or hovering touch.

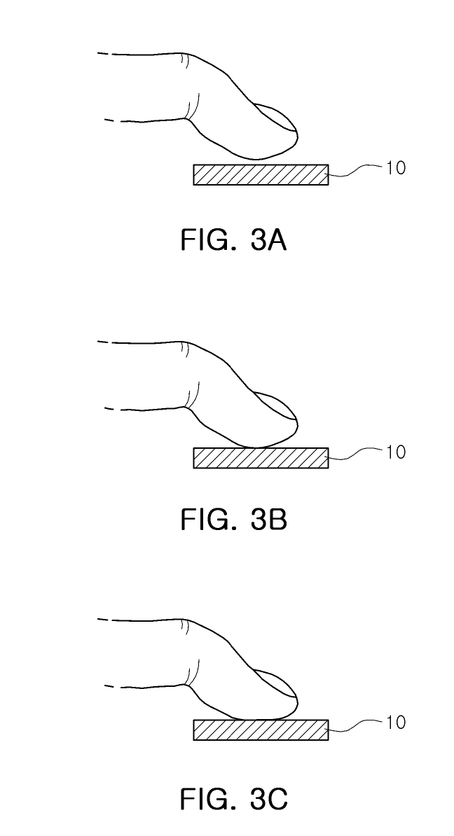

FIGS. 3A through 3C are views provided to describe classification of a touch according to an embodiment of the present invention, similar to FIG. 2. FIG. 3A, 3B and 3C show a finger as an example of the touch input apparatus and shows a side view of the electronic device 10 including the touchscreen 200.

Referring to FIGS. 2, 3A, 3B and 3C, the first touch in the embodiment of the present invention refers to the touch due to the change in capacitance generated in a state in which the finger does not contact the touchscreen 200 as shown in FIG. 3A.

Referring to FIG. 2, it may be appreciated that the third touch has the change in capacitance larger than that of the second touch. The change in capacitance is different depending on a type of the touch input apparatus, a contact area between the touch input apparatus and the touchscreen 200, and a contact time. Comparing FIGS. 3B and 3C with each other, it may be appreciated that the contact areas between the finger and the touchscreen 200 are differently shown in order to explain a difference in the change in capacitance. However, the difference in the change in capacitance is not limited to the contact area between the finger and the touchscreen 200.

The control unit according to the embodiment of the present invention may control the display unit 100 so as not to output a keyboard key corresponding to the first touch and the second touch in the display region 400 when sensing the first touch and the second touch, and may control the display unit 100 to display a letter of the keyboard key corresponding to the third touch in the display region 400 only when sensing the third touch having the third reference value or above in the keyboard touch region 300.

That is, the control unit may only judge a deep touch having a large change in capacitance such as the third touch as the touch for displaying the keyboard key in the display region 400, and may not judge a light touch having a small change in capacitance such as the first touch and the second touch, as the touch for displaying the keyboard key on a touch input display window.

However, this may be modified by a setting of a user. On the other hand, the control unit may also control the display unit 100 to display the letter of the keyboard key corresponding to the touch sensed when the second touch and the third touch having the second reference value or above are sensed, in the display region.

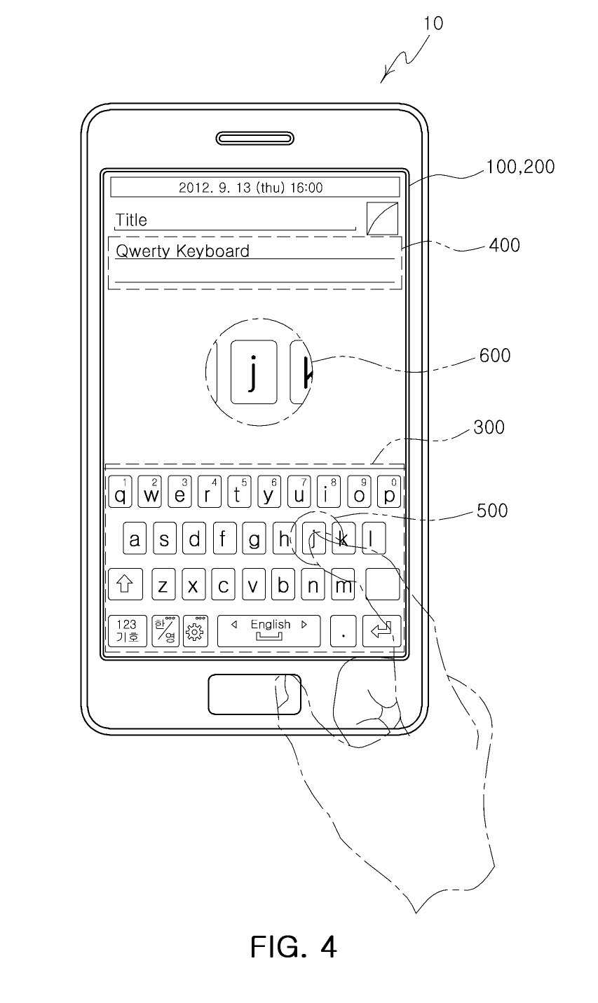

FIG. 4 is a view illustrating an expanded keyboard 600 according to an embodiment of the present invention. FIG. 4 shows a shape in which the finger, an example of the touch input apparatus, touches the keyboard touch region 300, specifically, in a vicinity of a keyboard key j of the touch keyboard. In this case, the touch may be the second touch and the third touch in which the finger contacts the touchscreen 200 and may be the first touch caused by the change in capacitance generated due to the finger spaced apart from the touchscreen 200 by a predetermined distance.

In addition, FIG. 4 shows a screen expanding the vicinity of the keyboard key j of the touch keyboard displayed on the display unit 100. A screen expanding a touch region 500 in the keyboard touch region 300 maybe referred to as an expanded keyboard as described below. Although FIG. 4 displays the expanded keyboard 600 as having a circular shape, it is not limited thereto, but may have a quadrangular and triangular shape and may also be modified by the user's setting.

The control unit may judge a type of touch and a position to which the touch is made when the touch is made. The control unit may control the display unit 100 to output the expanded keyboard 600 expanding the touch region 500 when it senses the first touch, the second touch, and the third touch and judges that the position to which the touch is made is in the keyboard touch region 300.

The expanded keyboard 600 is referred to as a screen expanding and displaying the touch region 500 input in the keyboard touch region 300. Specifically, the expanded keyboard 600 may refer to a screen expanding certain regions of the touch keyboard corresponding to the change in capacitance caused by any one of the first to third touches.

The control unit may control the display unit 100 to output the expanded keyboard 600 to a region other than the keyboard touch region 300. In addition, the control unit may control the display unit 100 to output the expanded keyboard 600 in a state in which the expanded keyboard 600 is spaced apart from a cursor included in the display region 400 by a predetermined distance.

According to the embodiment of the present invention, the typing error of the touch keyboard may be decreased by displaying the expanded keyboard 600 expanding the touch keyboard on the display unit 100 to thereby precisely recognize whether the touch input apparatus is at any position over the touch keyboard, even when the second touch and the third touch are sensed as well as when the first touch such as the floating touch is sensed, that is, even when the touch input apparatus does not contact the touchscreen 200.

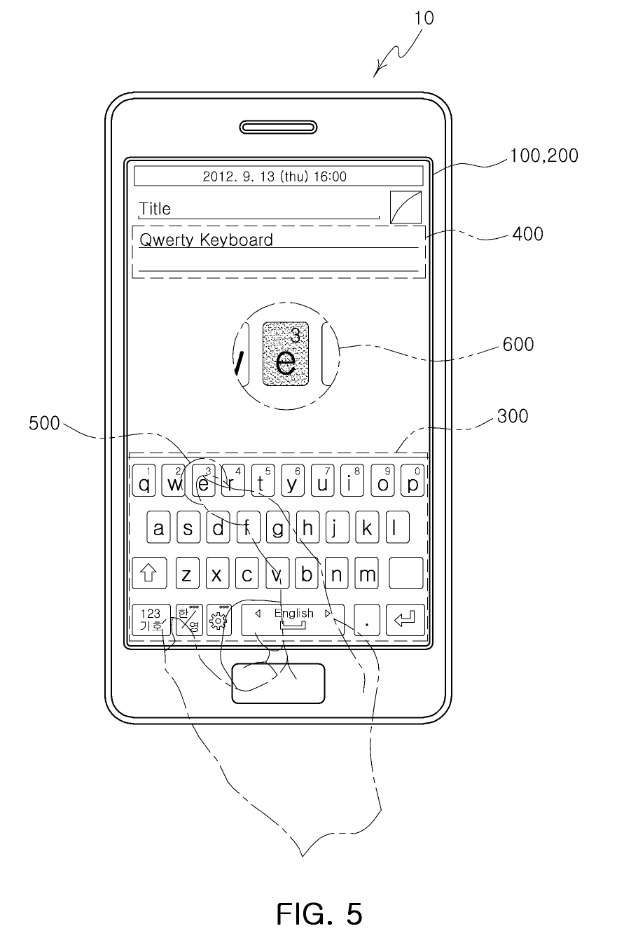

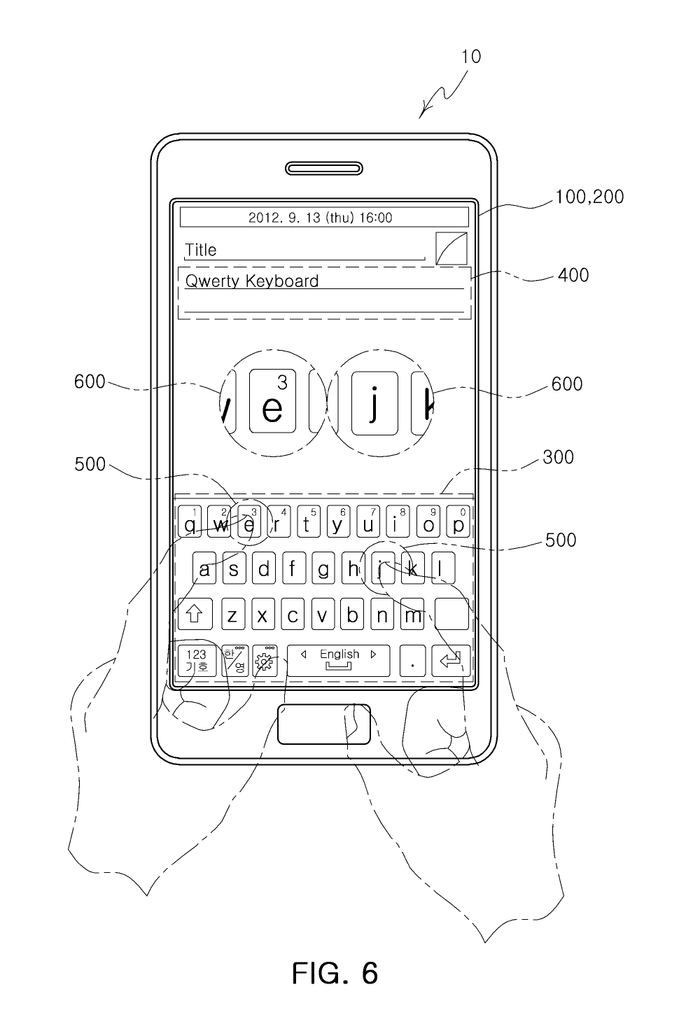

FIGS. 5 and 6 are views illustrating an expanded keyboard 600 according to an embodiment of the present invention, similar to FIG. 4.

When one of the first touch, the second touch, and the third touch is sensed in the keyboard touch region 300, the control unit may control the display unit 100 to display the keyboard key having the highest change in capacitance caused by the sensed touch among the keyboard keys included in the touch region 500 of the sensed touch, in the expanded keyboard with a preset emphasis color. The set emphasis colors may be different from each other to correspond to the first touch, the second touch, and the third touch, respectively.

FIG. 5 is a view illustrating a virtual keyboard according to an embodiment of the present invention.

From FIG. 5, it may be appreciated that the finger, an example of the input apparatus, touches in a vicinity of a keyboard key e among the keys of the touch keyboard. It may be appreciated that keyboard keys w, e, and r are included in the touch region 500, but the control unit displays e, the keyboard key having the highest change in capacitance, by deeply emphasizing the color thereof. The keyboard key having the highest change in capacitance in the expanded keyboard 600 region expanding the touch region 500 is displayed with the emphasis color, such that the typing error of the touch keyboard may be decreased.

In addition, when one of the first touch, the second touch, and the third touch is sensed in plural or the touches corresponding to the first touch, the second touch, and the third touch are sensed in plural in the keyboard touch region 300, the control unit may control the display unit 100 to output a plurality of the expanded keyboards 600 corresponding to the plurality of sensed touches, respectively.

Referring to FIG. 6, it may be appreciated that the finger, an example of the input apparatus, touches in a vicinity of a keyboard key e and in a vicinity of a keyboard key j among keys of the touch keyboard. In this case, it may be appreciated that the expanded keyboard 600 corresponds to a touch of the vicinity of the keyboard key e and a touch of the vicinity of the keyboard key j, such that two expanded keyboards 600 are output on the display unit 100.

By respectively displaying the expanded keyboards 600 corresponding to the plurality of touches, even in the case in which the touch is made using a plurality of fingers or both hands, the typing error may be efficiently prevented.

As set forth above, according to the embodiment of the present invention, the position of a finger may be confirmed even before a touch is made to the touch keyboard, such that a typing error may be efficiently prevented when being input through the touch keyboard.

While the present invention has been shown and described in connection with the embodiments, it will be apparent to those skilled in the art that modifications and variations can be made without departing from the spirit and scope of the invention as defined by the appended claims.

What is claimed is:

1. A touchscreen device, comprising:
a display unit outputting a keyboard touch region including a touch keyboard;
a touchscreen to which a touch is made; and
a control unit controlling the display unit to output an expanded keyboard having a preset shape by expanding a touch region of a first touch when the first touch is sensed in the keyboard touch region,
wherein the first touch is a floating or hovering touch.

2. The touchscreen device of claim 1, wherein the touch keyboard includes a plurality of keyboard keys, and
the control unit controls the display unit to display the keyboard key having the highest change in capacitance caused by the first touch among the keyboard keys included in the touch region of the first touch in the expanded keyboard, with a preset emphasis color, when the first touch is sensed in the keyboard touch region.

3. The touchscreen device of claim 1, wherein the control unit controls the display unit to output a plurality of the expanded keyboards corresponding to a plurality of first touches, respectively, when the plurality of first touches are sensed in the keyboard touch region.

4. The touchscreen device of claim 1, wherein the preset shape is one of a circular shape, a quadrangular shape, and a triangular shape.

5. The touchscreen device of claim 1, wherein the control unit controls the display unit to output the expanded keyboard in a region of a screen other than the keyboard touch region.

6. The touchscreen device of claim 1, wherein the display unit includes a display region for displaying a preset letter corresponding to a keyboard key of the touch keyboard, and
the control unit controls the display unit to output the expanded keyboard in a state in which the expanded keyboard is spaced apart from a cursor included in the display region by a predetermined distance.

7. A touchscreen device, comprising:
a display unit outputting a keyboard touch region including a touch keyboard;
a touchscreen to which a touch is made; and
a control unit controlling the display unit to output an expanded keyboard having a preset shape by expanding a touch region of a sensed touch when one of a first touch, a second touch, and a third touch is sensed in the keyboard touch region,
wherein the first touch has a change in capacitance from a preset first reference value or above to below a preset second reference value, the second touch has a change in capacitance from the second reference value or above to below a preset third reference value, and the third touch has a change in capacitance of the third reference value or above.

8. The touchscreen device of claim 7, wherein the touch keyboard includes a plurality of keyboard keys, and
the control unit controls the display unit to display the keyboard key having the highest change in capacitance caused by a sensed touch among the keyboard keys included in the touch region of the sensed touch in the expanded keyboard, with a preset emphasis color, when one of the first touch, the second touch, and the third touch is sensed in the keyboard touch region.

9. The touchscreen device of claim. 8, wherein the preset emphasis colors are different from each other to correspond to the first touch, the second touch, and the third touch, respectively.

10. The touchscreen device of claim 6, wherein the control unit controls the display unit to output a plurality of the expanded keyboards corresponding to a plurality of sensed touches, respectively, when one of the first touch, the second touch, and the third touch is sensed in the keyboard touch region in plural.

11. The touchscreen device of claim 6, wherein the control unit controls the display unit to output a plurality of the expanded keyboard corresponding to a plurality of sensed touches, when a plurality of touches corresponding to the first touch, the second touch, and the third touch, are respectively sensed in the keyboard touch region.

12. The touchscreen device of claim 7, wherein the display unit includes a display region for displaying a preset letter corresponding to a keyboard key of the touch keyboard, and
the control unit controls the display unit to output the letter of the keyboard key corresponding to a touch having the second reference value or above in the display region, when the touch having the second reference value or above is sensed in the keyboard touch region.

13. The touchscreen device of claim 7, wherein the display unit includes a display region for displaying a preset letter corresponding to a keyboard key of the touch keyboard, and
the control unit controls the display unit to output the letter of the keyboard key corresponding to a touch having the third reference value or above in the display region, when the touch having the third reference value or above is sensed in the keyboard touch region.

14. The touchscreen device of claim 7, wherein the control unit controls the display unit to output the expanded keyboard in a region of a screen other than the keyboard touch region.

15. The touchscreen device of claim 7, wherein the display unit includes a display region for displaying a preset letter corresponding to a keyboard key of the touch keyboard, and
the control unit controls the display unit to output the expanded keyboard in a state in which the expanded keyboard is spaced apart from a cursor included in the display region by a predetermined distance.

16. The touchscreen device of claim 7, wherein the preset shape is one of a circular shape, a quadrangular shape, and a triangular shape.

17. An electronic device comprising the touchscreen device of claim 1.

18. An electronic device comprising the touchscreen device of claim 7.
